(19) United States
(12) Patent Application Publication
(10) Pub. No.: US 2026/0058537 A1
(43) Pub. Date: Feb. 26, 2026

(54) BURST MODE IN FLYBACK POWER CONVERTERS

(71) Applicant: Texas Instruments Incorporated, Dallas, TX (US)

(72) Inventors: Bharat Agrawal, Bangalore (IN); Bing Lu, Bedford, NH (US); Akhila Gundavarapu, Bangalore (IN); Suvadip Banerjee, Bangalore (IN)

(21) Appl. No.: 19/087,131

(22) Filed: Mar. 21, 2025

Related U.S. Application Data
(60) Provisional application No. 63/685,077, filed on Aug. 20, 2024.

(51) Int. Cl. H02M 1/00; H02M 3/335

(52) U.S. Cl. CPC H02M 1/0035; H02M 3/33507

(57) ABSTRACT

Techniques are described herein for improving the burst operation of flyback power converters. The techniques provide a burst mode that delivers voltage pulses to a switching element with decreased power losses (e.g., greater switching efficiency). The efficiency of the power converter can be improved by capping the number of pulses to be delivered in a given burst packet and instituting a fixed delay to limit the power delivery. The pulses may be delivered during valleys of the signal at the switching terminal of the switching element to reduce switching losses. Additionally, a frequency clamp circuit is also provided to ensure the switching frequency is not above a predetermined threshold frequency. A device designed to implement the improved burst operation includes a burst control circuit, a pulse control circuit, a delay control circuit, and a latch.

### CROSS-REFERENCE TO RELATED APPLICATION

This application claims the benefit of U.S. Provisional Ser. No. 63/685,077 filed on Aug. 20, 2024, which is incorporated herein by reference in its entirety.

### TECHNICAL FIELD

This description relates to power converters, and in particular, to burst mode in flyback power converters.

### BACKGROUND

A flyback power converter is a switch mode power supply that converts an AC or DC input voltage to one or more regulated DC output voltages. A flyback converter topology generally includes an input capacitor, a primary-side switching element (e.g., metal oxide semiconductor field effect transistor, or MOSFET), a coupled inductor called a flyback transformer, an output diode or rectifier, and an output capacitor. The transformer allows for energy storage, energy transfer, and galvanic isolation between the input and any outputs. The turns ratio between the primary and secondary windings of the transformer can be set to enable the output voltage to be lower or higher than the input voltage. In operation, when the primary-side switching element is closed (on-time), the primary winding of the transformer is connected to the input voltage and the primary-side current ramps up, thus storing energy in the gap or core of the transformer. During this on-time, the output diode is reverse-biased and off, and the output capacitor supplies the load current. When the primary-side switching element is open (off-time), the energy in the transformer transfers to the secondary and current flows through the output diode that is now forward-biased, thereby replenishing the output capacitor and supplying the load current. During this process, the secondary-side current ramps down as the transformer core demagnetizes. Some flyback converters use an auxiliary transformer winding for valley sensing and overvoltage-protection, and to generate a low-voltage bias supply. A number of non-trivial issues remain with flyback power converters.

### SUMMARY

In an example, a device includes a burst control circuit configured to receive a feedback voltage of a power converter and generate a burst enable signal, a pulse control circuit configured to receive the burst enable signal and a voltage signal of a current terminal of a switching element of the power converter, a delay control circuit configured to initiate a delay time, and a latch. The pulse control circuit is further configured to determine a timing between pulses to be delivered to the control terminal of the switching element and to assert a pulse enable signal. The delay time is initiated by the delay control circuit responsive to a delivered number of pulses reaching a maximum pulse threshold. The latch is designed to receive the pulse enable signal and a pulse reset signal, and to output a pulse to the control terminal of the switching element.

In another example, a control circuit includes a valley counting circuit configured to count a number of valleys detected in a received voltage signal, a frequency clamp circuit configured to determine if a burst frequency corresponding to a time of a currently detected valley is less than a threshold frequency, and one or more logic gates. The valley counting circuit also asserts a valley enable signal upon counting one or more valleys in the received voltage signal. The frequency clamp circuit also asserts a clamp signal responsive to the burst frequency being less than the threshold frequency. The one or more logic gates are designed to receive at least the valley enable signal and the clamp signal and to assert a pulse enable signal at an output terminal of the one or more logic gates.

In another example, a device includes a burst control circuit configured to receive a feedback voltage of a power converter and generate a burst enable signal, a control circuit configured to receive the burst enable signal and a voltage signal of a current terminal of a switching element of the power converter, and a digital storage element. The control circuit is further configured to determine a timing between pulses to be delivered to a control terminal of the switching element, assert a pulse enable signal to deliver a pulse, and count a number of delivered pulses and determine if the number of delivered pulses is less than a maximum pulse threshold. The digital storage element is configured to receive the pulse enable signal and to output a pulse to the control terminal of the switching element.

In another example, a method includes: delivering a first pulse at a first time to a control terminal of a switching element; detecting, at a second time, a first valley in a switching signal sampled at a current terminal of the switching element; and determining whether a first burst frequency associated with a time difference between the first time and the second time is less than a threshold frequency. Responsive to the first burst frequency being less than the threshold frequency, the method includes delivering a second pulse at the second time to the control terminal of the switching element. Responsive to the first burst frequency being greater than the threshold frequency, the method includes detecting, at a third time, a second valley in the switching signal, determining whether a second burst frequency associated with the time difference between the first time and the third time is less than the threshold frequency, and responsive to the second burst frequency being less than the threshold frequency, delivering a second pulse at the third time to the control terminal of the switching element.

### BRIEF DESCRIPTION OF THE DRAWINGS

FIG. 1 illustrates a block diagram of a flyback power converter system that includes a control circuit configured to provide a burst mode operation, in an example.

FIG. 2 illustrates a block diagram of a flyback power converter control circuit configured to provide a burst mode operation, in an example.

FIG. 3 illustrates a schematic diagram of a burst control circuit of the control circuit of FIG. 2, in an example.

FIG. 4 illustrates a schematic diagram of a pulse control circuit of the control circuit of FIG. 2, in an example.

FIG. 5 illustrates a schematic diagram of a frequency clamp circuit of the pulse control circuit of FIG. 4, in an example.

FIG. 6 illustrates a schematic diagram of a delay control circuit of the control circuit of FIG. 2, in an example.

FIG. 7 illustrates plots of signals generated by the system of FIG. 1 during a burst mode operation, in an example.

FIG. 8 illustrates a flow chart of a method for a burst mode in a flyback power converter, in an example.

FIG. 9 illustrates a block diagram of a system including a flyback power converter, in an example.

### DETAILED DESCRIPTION

Techniques are described herein for providing a burst mode operation of flyback power converters. The techniques provide a burst mode that delivers voltage pulses to a switching element with decreased or otherwise relatively low power losses (e.g., greater switching efficiency). The efficiency of the power converter can be improved by capping the number of pulses to be delivered in a given burst packet and instituting a fixed delay to limit the power delivery. The pulses may be delivered during valleys of the signal at the switching terminal of the switching element to further reduce switching losses. However, switching at, for example, the first valley of the signal may result in the switching frequency being too high, which can cause electromagnetic interference (EMI) in the system. Accordingly, a frequency clamp circuit is also provided to ensure the switching frequency is not above a predetermined threshold. In an example, a device designed to implement the improved burst operation described above includes a burst control circuit, a pulse control circuit, a delay control circuit, and a latch. The burst control circuit may be configured to determine when to enter and exit the burst mode operation based at least on a feedback voltage from a connected load. The pulse control circuit may be configured to determine the timing of pulses to be delivered to a switching element of the power converter. The delay control circuit may be configured to provide a predetermined delay after delivering a set number of pulses to improve the efficiency of the power delivery. The latch may be designed to output pulse width-modulated (PWM) signals based on received input from at least the pulse control circuit. Numerous configurations will be apparent in light of the disclosure.

### General Overview

As described above, a number of non-trivial issues remain with flyback power converters. Various electrical and power standards are increasingly demanding that electrical power systems become more efficient. For example, the current European Union Ecodesign Requirements (EUER) standard for universal serial bus (USB) power delivery requires no more than 300 mW of input power for 210 mW of output power. Achieving this benchmark is challenging. In more detail, when operating in standby mode or otherwise under minimal to no load conditions, flyback power converter topologies use a burst mode to deliver a series of voltage pulses to the gate terminal of a switching element to help achieve lower power losses. During this burst mode, a hysteretic control may be implemented to handle the load demand. The switching element is on (closed) when the load demands power, and the switching frequency is typically operated above the audible frequency range (e.g., in excess of 20 kHz, at around 25 kHz). However, during this burst mode operation, relatively high switching losses may occur as the switch is turned on at a DC input voltage, rather than during a valley of the ringdown exhibited in the signal at the switching terminal. While switching at the signal valleys can help alleviate some of these switching losses, it may still be difficult to consistently meet the standard as set forth by the EUER. Also, the standard of a given application may be stricter than that of the EUER, thereby exacerbating the problem.

Accordingly, techniques are described herein for providing a flyback power converter with a more efficient burst mode operation. In an example, the techniques can be implemented by a controller having one or more circuits configured to provide PWM signals to control the on-time of a switching element (e.g., a MOSFET). The signal produced at the switching terminal of the switching element (e.g., a drain terminal of the MOSFET) may include a ringing (or resonant) portion during periods of time that the switching element is off (also referred to as off-time). During the burst mode, signal valleys during the ringing portion of the signal may be identified and used to trigger the generation of additional pulses to turn the switching element back on. According to some embodiments, the number of sequential pulses delivered in this way for a given burst packet may be capped at a predetermined number to reduce the switching loss. According to some embodiments, a fixed delay is instituted after delivering the predetermined number of pulses to limit the power delivery. According to some embodiments, the switching frequency during the burst mode is clamped below a threshold to limit the switching frequency. In this way, if switching at a first valley in the signal would cause the switching frequency to be too high, then switching is attempted at the next valley in the signal and so forth until the switching frequency is below the threshold.

According to some embodiments, a flyback power converter controller includes a burst control circuit, a pulse control circuit, a delay control circuit, and a latch or other comparable storage element. The burst control circuit uses any number of comparators along with different threshold voltage levels to compare with a feedback voltage received from a connected load. The comparisons may be used to determine when to enter and exit the burst operation mode. The pulse control circuit may include a valley sensing circuit, a valley counter, and a frequency clamp circuit that work in conjunction with digital logic to determine the timing between sending pulse enable signals to the latch. The delay control circuit may be designed to count the number of pulses and, once the number has reached a max value, assert a delay signal to prevent any further pulses from being provided to the switching element for a fixed delay period.

### Power Converter Architecture

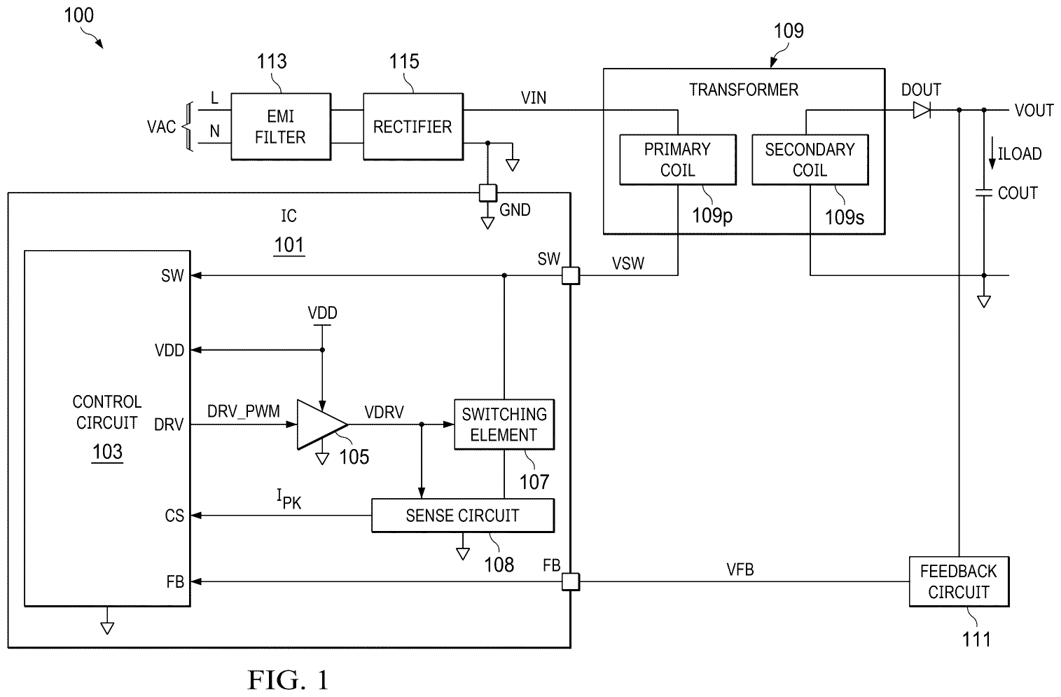

FIG. 1 illustrates a block diagram of a flyback power converter system 100 that includes a control circuit configured to provide a burst mode of operation, in an example. As shown, system 100 includes an integrated circuit (IC) 101, a flyback transformer 109, an output diode DOUT, an output capacitor COUT, a feedback circuit 111, an electromagnetic interference (EMI) filter 113, and a rectifier 115. In this example, flyback power converter system 100 converts an AC input voltage (VAC) to a DC input voltage (VIN) which is then converted by system 100 to a regulated DC output voltage (VOUT). In other examples, the DC input voltage VIN may be sourced directly, rather than derived from AC input voltage VAC.

As further shown, IC 101 includes a control circuit 103, a driver 105, a switching element 107, and a sense circuit 108. Each of the components of IC 101 may be populated on a given substrate, such as on or otherwise part of an integrated circuit die within an integrated circuit package (e.g., ceramic flat pack with leads, dual in-line, ball grid array, pin grid array, land grid array, leaded chip carrier, quad flat no lead, to name a few examples), or on or otherwise part of a printed circuit board (e.g., single-sided, double-sided, multilayer, flex, to name a few examples), or on or otherwise part of any other suitable substrate upon which circuitry may be formed and/or populated. In some examples, control circuit 103 may represent a separate controller, which may be part of its own die or substrate.

Each of flyback transformer 109, DOUT, COUT, feedback circuit 111, EMI filter 113, and rectifier 115 are shown to be external to IC 101 in this example, but in other examples any one or more of these components or circuits may be integrated within IC 101. An electronic system to be powered may also be coupled between VOUT and ground terminals of system 100. The electronic system, represented here as a load current (ILOAD), may be configured to suit any number of applications (e.g., automotive systems, computing systems, communications systems, gaming systems, household appliances and consumer electronic systems, mobile electronic systems such as smartphones, or any other application that utilizes regulated power). Other examples of flyback power converter system 100 may include additional components not shown and/or be configured differently, and any such systems may benefit from the techniques described herein.

EMI filter 113 removes unwanted noise from being injected into the line voltage, and rectifier 115 rectifies the AC input. Any suitable EMI filter and rectifier circuitry can be used. Other examples may have VIN directly applied rather than derived from an AC source as shown. In such cases, system 100 may not include EMI filter 113, and rectifier 115. Transformer 109 allows for energy storage, energy transfer, and galvanic isolation between the input voltage VIN and output voltage VOUT. The turns ratio between the primary and secondary windings 109p and 109s, respectively, can be set to enable VOUT to be lower or higher than VIN. Any suitable flyback transformer may be used.

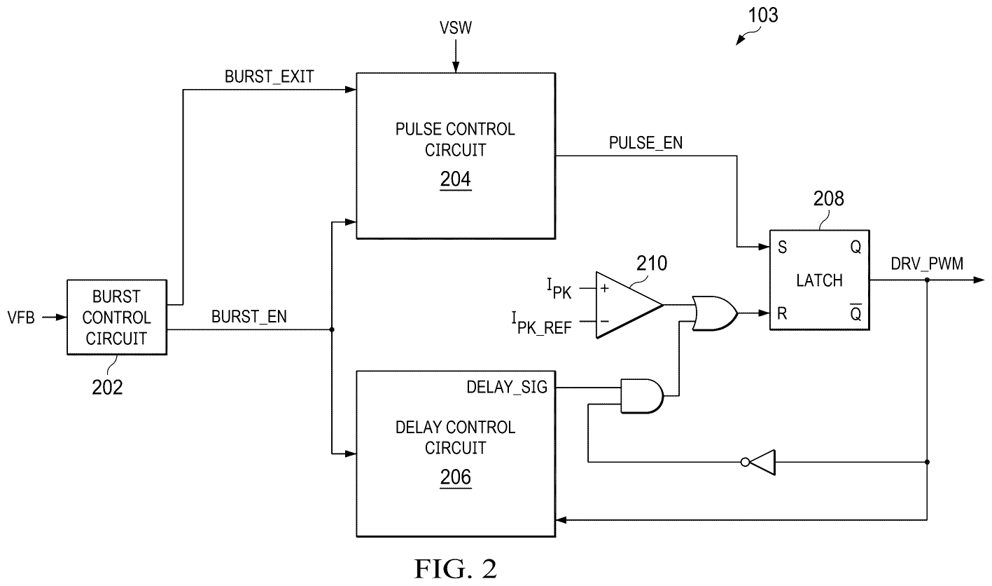

Switching element 107 can be any suitable switching element technology, such as a gallium nitride field effect transistor (GaN FET) or other power FET, or a power bipolar junction transistor (BJT). In this example, switching element 107 is coupled between a switching terminal (SW) and a ground terminal of IC 101 via its current terminals (e.g., source/drain terminals for a FET, or emitter/collector terminals for a BJT), with sense circuit 108 coupled between switching element 107 and ground. The control terminal (e.g., gate terminal for a FET, or base terminal for a BJT) of switching element 107 is coupled to the output of driver 105. When switching element 107 is closed (on-time), primary winding 109p is connected to the input voltage VIN and the primary-side current ramps up, thus storing energy in the core of transformer 109. During this on-time, diode DOUT is reverse-biased and off, and capacitor COUT supplies the load current. When switching element 107 is open (off-time), energy stored in the core of transformer 109 transfers to the secondary winding 109s and current flows through diode DOUT (now forward-biased), thereby replenishing capacitor COUT and supplying the load current ILOAD. During this process, the secondary-side current ramps down as the transformer 109 core demagnetizes. The closing and opening of switching element 107, including valley switching and burst mode operation, is controlled by control circuit 103, as further explained below with reference to FIG. 2.

Sense circuit 108 senses the primary-side peak current I_{PK} and provides that current information (which may be a scaled version of the actual primary-side peak current I_{PK}) to control circuit 103. The peak current I_{PK} depends on ILOAD and the input line conditions. Any suitable current sensing circuitry that allows control circuit 103 to receive or otherwise determine the primary-side peak current I_{PK} may be used, such as a resistor-based current sensing circuit that includes a sense FET or BJT that is a scaled down replica of switching element 107. Feedback circuit 111 senses the output voltage and provides a feedback voltage VFB signal to control circuit 103. The VFB signal may be, for instance, a representation of the output power. Any suitable feedback circuitry that allows control circuit 103 to receive or otherwise determine VOUT may be used, such as a resistive divider and/or an optocoupler feedback circuit as is sometimes used in flyback topologies.

As further shown, the input voltage VIN is applied to one terminal of the primary-side winding of transformer 109, and the other terminal of the primary-side winding is coupled to the switching terminal (SW), so that IC 101 receives the switching terminal voltage (VSW) signal. Also, a system ground (GND) is coupled to a ground terminal of IC 101, and the VFB signal generated by feedback circuit 111 is coupled to a feedback (FB) terminal of IC 101. Also, a power supply voltage VDD may be generated on IC 101, or received via another terminal of IC 101, and can be used to power circuitry therein as needed. Other examples may be configured differently and/or include other componentry, and any such configurations may benefit from the techniques described herein.

### Burst Mode Controller Architecture

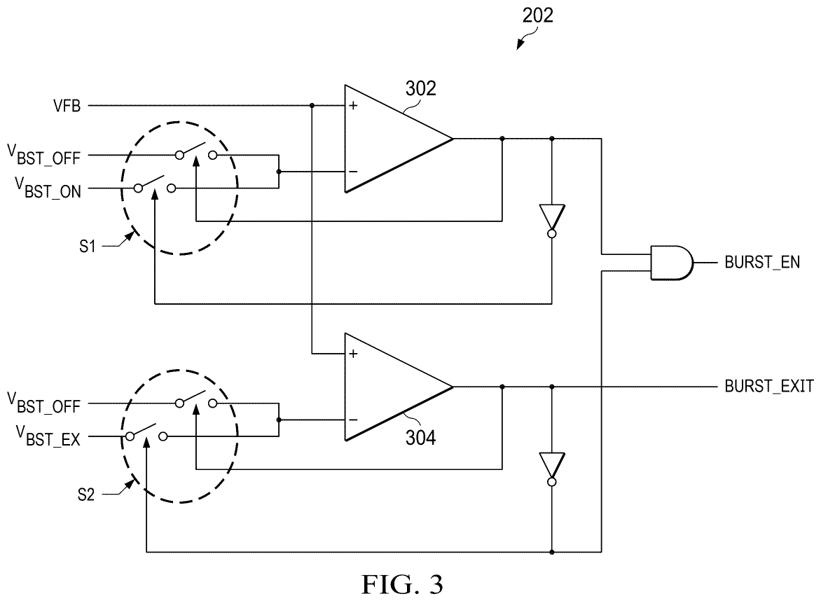

FIG. 2 illustrates a block diagram of at least a portion of control circuit 103, according to some embodiments. Each block may be implemented using any combination of logic gates and/or analog circuitry to carry out the functions described herein. Examples of the particular circuit blocks are also provided with reference to FIG. 3 - 6. According to some embodiments, control circuit 103 includes at least a burst control circuit 202, a pulse control circuit 204, a delay control circuit 206, and a latch 208.

Burst control circuit 202 may be designed to receive the feedback voltage signal VFB and determine when to enter or exit from the burst mode of operation based at least on the value of the feedback voltage VFB. Burst control circuit 202 may use any number of comparator circuits to compare the feedback voltage VFB against different threshold levels to determine whether to assert a BURST_EN signal (e.g., signifying that the burst mode is enabled) or to assert a BURST_EXIT signal (e.g., signifying that the burst mode has ended). Further details of burst control circuit 202 may be found with reference to FIG. 3.

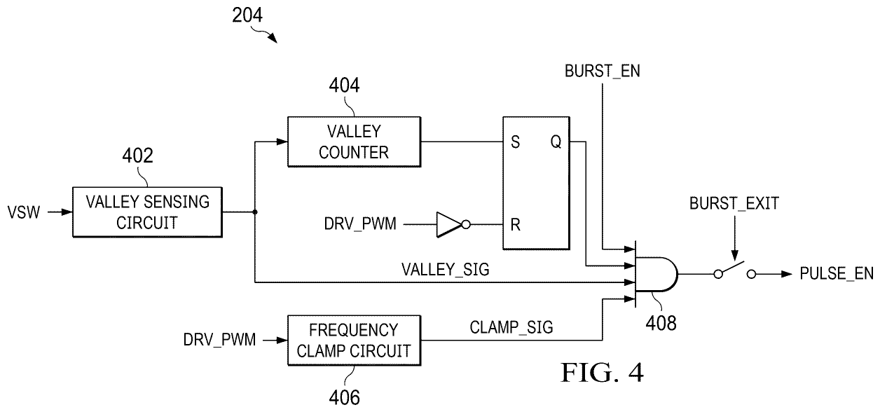

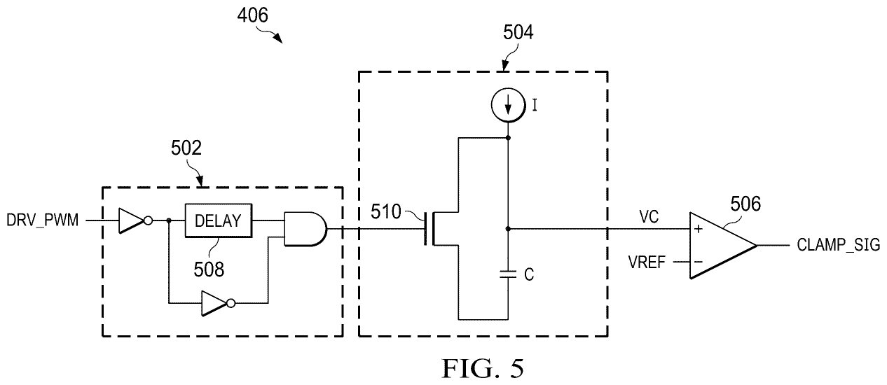

Pulse control circuit 204 may be designed to receive various signals, such as at least the switching terminal voltage signal (VSW), and determine when to assert a PULSE_EN signal, which represents when to send a signal pulse to the control terminal of switching element 107, according to some embodiments. Pulse control circuit 204 may include various circuits to perform a variety of functions related to controlling the timing between pulses sent in a given burst packet. Accordingly, pulse control circuit 204 may include at least some circuitry associated with identifying one or more valleys in the switching terminal voltage signal (VSW) as well as at least some circuity associated with determining a switching frequency and clamping the switching frequency to ensure it is not higher than a predetermined threshold frequency. Further details of pulse control circuit 204 may be found with reference to FIGS. 4 and 5.

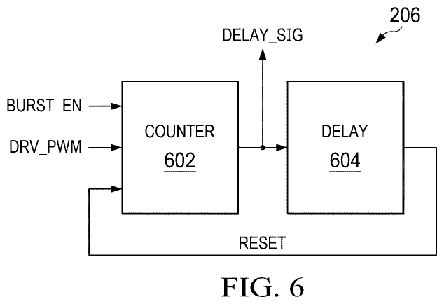

Delay control circuit 206 may be designed to receive the output PWM signal (DRV_PWM) and determine when to assert a delay signal (DELAY_SIG) to prevent any further pulses during the delay period, according to some embodiments. In an example, delay control circuit 206 includes a counter to count the number of sequential pulses delivered (e.g., based on DRV_PWM) and a delay timer to determine how long to wait before resetting the counter. The state of the delay signal DELAY_SIG may be held at a given value (e.g., logic HIGH) during the entire delay period and toggled to another value (e.g., logic LOW) at the expiration of the delay period. Further details of delay control circuit 206 may be found with reference to FIG. 6.

According to some embodiments, latch 208 is configured to output a PWM signal (DRV_PWM) to drive the on-time of switching element 107. The rising edge of a given pulse is asserted when PULSE_EN toggles HIGH and the falling edge of the given pulse is asserted when the latch is reset (e.g., the R input receives a logic HIGH signal). According to some embodiments, the falling edge of a given pulse occurs when the primary-side peak current I_{PK} rises higher than a threshold current value (I_{PK_REF}), as may be determined using a comparator 210. According to some embodiments, an asserted delay signal DELAY_SIG from delay control circuit 206 may also hold the reset terminal R of latch 208 at a logic HIGH, which forces the output Q to be LOW for the remainder of the delay period, regardless of the state of PULSE_EN. In some examples, additional digital logic, represented here by the NOT gate and the AND gate, may be used to ensure that the delay signal DELAY_SIG does not reset the latch during the delivery of a voltage pulse. Although latch 208 is provided to deliver pulse width-modulated signals, it should be understood that any digital storage element(s) could be used as well, such as cascaded flip-flops.

FIG. 3 illustrates a more detailed schematic of burst control circuit 202, according to an embodiment. Burst control circuit 202 includes a first comparator 302 and a second comparator 304 that each receive the feedback voltage VFB. In an example, first comparator 302 receives VFB at its positive input terminal and second comparator 304 also receives VFB at its positive input terminal. The negative input terminal of first comparator 302 and second comparator 304 is configured to receive a reference voltage for comparison to the feedback voltage VFB, according to some embodiments. For example, first comparator 302 is designed to receive either a first reference voltage V_{BST_OFF} or a second reference voltage V_{BST_ON} depending on the state of switches S1 and second comparator is designed to receive either the first reference voltage V_{BST_OFF} or a third reference voltage V_{BST_EX} depending on the state of switches S2. The values of each of the references voltages may be predetermined to set the voltage levels at which the system enters and exits burst mode operation. In the illustrated example, a same first reference voltage V_{BST_OFF} can be received at the negative terminal of both first comparator 302 and second comparator 304, but in other examples, different voltage levels are used for these reference voltages between the two comparators.

According to some embodiments, first reference voltage V_{BST_OFF} represents a voltage at which the system stops providing pulses, but does not exit from burst mode, second voltage reference V_{BST_ON} represents a voltage at which the system begins to provide pulses during the burst mode, and third reference voltage V_{BST_EX} represents a voltage at which the system exits from the burst mode. In an example, first reference voltage V_{BST_OFF} is less then second voltage reference V_{BST_ON}, and second voltage reference V_{BST_ON} is less than third reference voltage V_{BST_EX}. In an example, first reference voltage V_{BST_OFF} is around 0.25 V, second voltage reference V_{BST_ON} is around 0.30 V, and third reference voltage V_{BST_EX} is around 0.5 V.

The operation of burst control circuit 202 will now be discussed by way of an example using the values for the various reference voltages noted above. When the feedback voltage VFB is less than 0.25 V (e.g., the value of first reference voltage V_{BST_OFF}), the output of first comparator 302 is a logic LOW, which causes switches S1 to connect the second reference voltage (V_{BST_ON}) to the negative input terminal of first comparator 302. Similarly, the output of second comparator 304 is also a logic LOW, which causes switches S2 to connect the third reference voltage (V_{BST_EX}) to the negative input terminal of second comparator 304. As long as VFB remains below 0.3 V (e.g., the value of second reference voltage V_{BST_ON}), both BURST_EN and BURST_EXIT signals are not asserted.

Once VFB rises above 0.3 V (e.g., due to the load demanding power), the output of first comparator 302 changes to a logic HIGH, which causes switches S1 to connect the first reference voltage (V_{BST_OFF}) to the negative input terminal of first comparator 302. The value of VFB is not yet higher than the value of the third reference voltage V_{BST_EX}, so second comparator 304 continues to output a logic LOW. At this time, BURST_EN is asserted, and voltage pulses can be sent to the switching element. BURST_EXIT remains at a logic LOW level as VFB has not yet risen to the level of 0.5 V (e.g., the value of third reference voltage V_{BST_EX}). As long as VFB remains between 0.25 V and 0.5 V, the system will remain in the burst mode with the BURST_EN signal asserted. If, however, VFB rises beyond 0.5 V, then the output of second comparator 304 changes to a logic HIGH, which causes switches S2 to connect the first reference voltage (V_{BST_OFF}) to the negative input terminal of second comparator 304 and asserts the BURST_EXIT signal. This also simultaneously de-asserts the BURST_EN signal as the AND gate now receives a logic LOW signal from the inverted output of second comparator 304. On the other hand, if VFB falls below 0.25 V, then the output of first comparator 302 changes to a logic LOW, which causes switches S1 to connect the second reference voltage (V_{BST_ON}) to the negative input terminal of first comparator 302. Burst pulses can then be re-enabled once the feedback voltage VFB rises above 0.3 V.

FIG. 4 illustrates a more detailed schematic of pulse control circuit 204, according to an embodiment. One or more logic gates (represented here as a single AND gate 408) may be used to receive various signals and output a pulse enable signal PULSE_EN. In some examples, the pulse enable signal PULSE_EN toggles HIGH when a pulse is to be delivered to the switching element 107. Pulse control circuit 204 may further include a valley sensing circuit 402, a valley counter 404, and a frequency clamp circuit 406.

According to some embodiments, valley sensing circuit 402 receives the switching voltage signal VSW at the switching terminal SW and identifies the presence of one or more signal valleys in the signal. Briefly, VSW exhibits a ring down period following the switching element 107 turning off. Thus, several sequential signal valleys exist during the ring down period. Valley sensing circuit 402 is configured to identify when VSW is at a valley and to assert an output signal (VALLEY_SIG) to represent the presence of a valley in VSW. In this way, the system can assert the next pulse during a valley of the switching voltage VSW. In some embodiments, valley sensing circuit 402 uses a high voltage capacitor and a resister divider to replicate the VSW signal in a lower voltage domain and detect the low point in the signal. Further details regarding an example operation of the valley sensing circuit 402 may be found in U.S. patent application Ser. No. 19/016,101, which is herein incorporated by reference in its entirety. Other embodiments may use different valley sensing circuitry to provide VALLEY_SIG, such as circuitry using an auxiliary winding of the flyback transformer 109 to sense valleys, or dedicated valley sensing circuitry included in control circuit 103. Also, while in some examples valleys are sensed in the VSW signal, other power converter signals that also manifest the valleys to be sensed may be used by valley sensing circuit 402, such as the primary-side voltage signal, which may or may not be a high-voltage signal, depending on the application. In any case, signal scaling can be used to convert the given signal to a lower-voltage domain, if so desired.

According to some embodiments, a valley counter 404 is provided to count the number of valleys in VSW that are passed before the pulse is ultimately asserted. Switching may occur at the first valley of the VSW signal, however as noted above, this may cause the switching frequency to be too high, thus higher order valleys in the VSW signal may be used instead to perform the switching. In some examples, valley counter 404 includes any suitable counter circuit to keep track of the number of valleys that are identified within the VSW signal (e.g., based on the received VALLEY_SIG signal from valley sensing circuit 402). In some embodiments, valley counter 404 provides an output to a latch or any other digital storage element to cause a voltage pulse to be asserted during a given counted valley. In some examples, the latch may be reset during any period of time when the PWM signal (DRV_PWM) is not asserted.

As noted above, the switching frequency, also referred to as a burst frequency, (e.g., related to the timing between pulses sent to switching element 107) may be clamped to ensure that it is not above a threshold switching frequency. According to some embodiments, a frequency clamp circuit 406 is used that receives the PWM signal (DRV_PWM) and, based on the switching frequency of the PWM signal, outputs a CLAMP_SIG signal that deactivates generating new pulses if the switching frequency is too high. Frequency clamp circuit 406 may be more generally referred to as a frequency detection circuit.

According to some embodiments, AND gate 408 represents any number of AND gates or any type of logic gates. AND gate 408 may generally receive the output from each of valley sensing circuit 402, valley counter 404, and frequency clamp circuit 406. The BURST_EN signal may also be used as an input to AND gate 408, such that no pulses can be produced if the BURST_EN signal is not asserted. According to some embodiments, a switch at the output of AND gate 408 is controlled by the BURST_EXIT signal. In this way, asserting the BURST_EXIT signal decouples all pulse control logic from the driver at the control terminal of the switching element 107. In other examples, BURST_EXIT is used to switch off any other portion of the circuit that leads to a similar outcome of exiting from burst control.

FIG. 5 illustrates a more detailed schematic of frequency clamp circuit 406, according to an embodiment. As noted above, frequency clamp circuit 406 receives the PWM signal DRV_PWM and determines whether the switching frequency of the PWM signal is greater than a threshold frequency. The threshold frequency may be a predetermined frequency based on the application. For example, the threshold frequency may be 250 kHz, such that pulses cannot be delivered at a switching frequency greater than 250 kHz. Any other threshold frequency value can be used. In general, frequency clamp circuit 406 includes a first stage 502 that converts the square wave DRV_PWM signal into shorter pulses at the rising edges of the square wave, a second stage 504 that controls the charging and discharging of a capacitor C, and a third stage that may be represented by a comparator 506 to compare the voltage across the capacitor C against a threshold voltage corresponding to the threshold frequency.

According to some embodiments, first stage 502 of frequency clamp circuit 406 includes an AND gate having a first input terminal that receives the PWM signal after passing through an inverter and a delay 508, and a second input terminal that receives the PWM signal after passing through sequential inverters. Delay 508 may represent a fixed delay time implemented using a cascaded number of inverters or other similar signal delay techniques. In some examples, delay 508 represents a delay between about 20 ns and about 50 ns, such as around 30 ns. By instituting the brief delay on the received signal, the AND gate will receive two HIGH inputs for only the brief amount of time corresponding to the length of delay 508, such that the output of the AND gate pulses HIGH following a rising edge on the square wave signal of DRV_PWM, according to some embodiments.

The output of the AND gate is received at the control terminal of a switching element 510 within second stage 504, according to some embodiments. Turning on switching element 510 causes capacitor C to discharge (e.g., VC becomes 0 or near 0). Once switching element 510 turns off, the current source I begins to charge C at a constant rate. Accordingly, VC will respectively rise at a constant rate. According to some embodiments, the state of CLAMP_SIG depends on the comparison between VC and VREF. As long as VC remains below VREF, CLAMP_SIG remains at a logic LOW, which prevents further pulses from being generated by pulse control circuit 204. If the switching speed is too fast (e.g., greater than the threshold frequency), switching element 510 will respectively turn on more quickly thus discharging capacitor C before VC can rise above VREF. However, once the switching frequency of DRV_PWM falls below the threshold frequency, capacitor C is able to charge long enough for VC to rise above VREF, thus asserting CLAMP_SIG and allowing the PULSE_EN signal to be asserted.

FIG. 6 illustrates a more detailed schematic of delay control circuit 206, according to an embodiment. Delay control circuit 206 includes at least a counter 602 that is configured to count the number of sequential pulses delivered to the switching element 107. In some examples, counter 602 counts the rising edges of the received PWM signal DRV_PWM to count the pulses.

According to some embodiments, counter 602 asserts DELAY_SIG in response to the count reaching a predetermined number of pulses. In some examples, counter 602 counts up to three pulses before asserting DELAY_SIG. Counter 602 may count up to any number of pulses before asserting DELAY_SIG, such as up to 8 pulses. Once counter 602 has counted up to the maximum number of pulses, the operation of counter 602 may pause while the asserted DELAY_SIG signal passes through a delay block 604 before resetting counter 602. According to some embodiments, the delay imposed upon the signal within delay block 604 is predetermined and may be based on the given application. In some examples, the signal delay imposed by delay block 604 is between about 40μs and about 120μs, such as around 70μs. Delay block 604 may be implemented using cascaded inverters or any other signal delay configuration. While DELAY_SIG is asserted (after counting up to the max number of pulses), the reset terminal of latch 208 (as seen in FIG. 2) is held on to prevent any further pulses from being sent to the switching element 107.

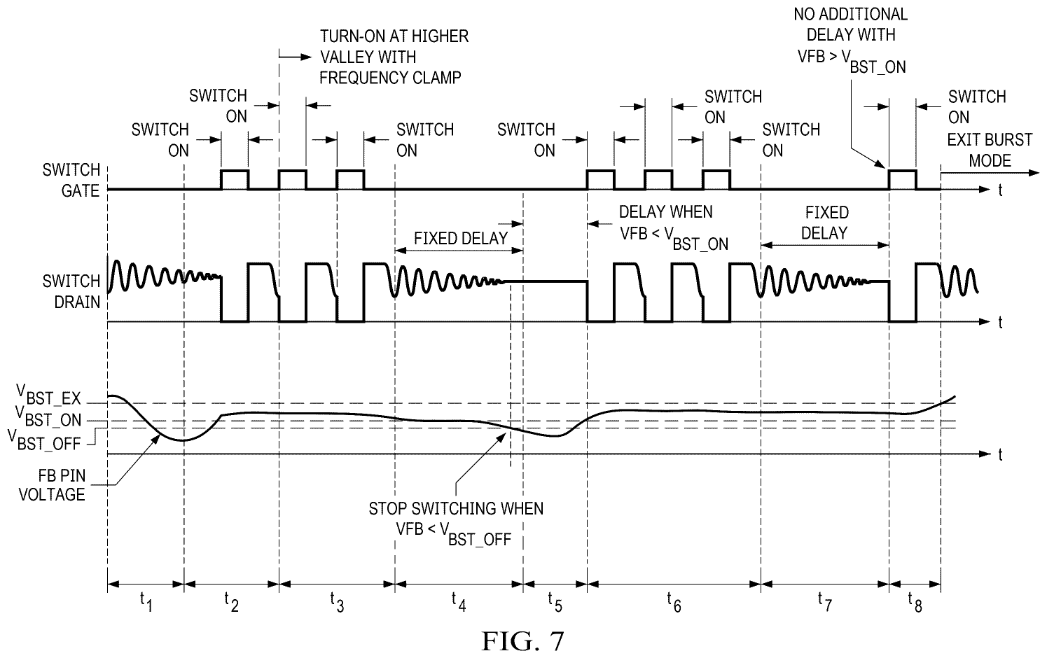

FIG. 7 illustrates plots of signals generated by the system of FIG. 1 due to the burst control mode performed by control circuit 103 of FIG. 2, according to some embodiments. Reference to any of the aforementioned figures may be made to further facilitate understanding, and the above relevant description is equally applicable here. The first (topmost) plot of FIG. 7 is the signal at the control terminal of switching element 107, and generally illustrates the various pulses when switching element 107 is turned on (also referred to herein as on-time). The second plot from the top shows the VSW signal at the switching terminal (e.g., the drain of switching element 107). The bottom plot shows the feedback voltage VFB along with different thresholds at which the burst operation changes. All three plots are illustrated along the same timeline.

During a first time period (t₁), the feedback voltage VFB begins high enough for the system to not be in the burst mode. According to some embodiments, VFB drops over time and eventually falls below the first voltage threshold V_{BST_OFF}. At this time, the system waits for VFB to rise back above the second voltage threshold V_{BST_ON} to begin sending pulses during the burst mode, according to some embodiments. As seen during a second time period (t₂) VFB has begun to rise as the load begins to demand more power, and eventually VFB rises above the second voltage threshold V_{BST_ON.} Once this happens, a first pulse is sent as observed by the square wave pulse received at the gate terminal of the switching element. At the end of the pulse, the switching element is off, and the voltage at the switching terminal will begin to ring down as the stored energy in the transformer is transferred to the load. According to some embodiments, the next pulse is sent during one of the valleys in the voltage signal at the switching terminal. In the illustrated example, the next pulse is sent at the first valley of the voltage signal at the switching terminal. However, as discussed above, if switching at the first valley would cause the switching frequency to be too high (e.g., above a predetermined threshold frequency), then the system would attempt to send the next pulse at the next valley instead, and so forth until the switching frequency would be less than the threshold frequency.

During a third time period (t₃), any number of additional pulses are provided to the gate terminal of the switching element. According to some embodiments, the number of sequentially delivered pulses is predetermined and stops after reaching a max threshold. In the illustrated example, three pulses are delivered by the end of the third time period t ₃ after which the system stops delivering pulses.

During a fourth time period t4, a fixed delay is enforced by the system, during which no additional pulses can be sent, according to some embodiments. As noted above, this fixed delay period may range between about 40μs and about 120μs. During the delay period, the voltage signal at the switching terminal continues to ring down, and in some cases, may reach a steady state voltage level by the end of the fixed delay period. According to some embodiments, VFB may slowly drop during the fixed delay period. In the illustrated example, VFB drops below the first voltage threshold V_{BST_OFF} during the delay period. Accordingly, the system stops attempting to generate pulses and will not generate any new pulses until VFB rises back above the second voltage threshold V_{BST_ON}. As can be observed during a fifth time period t₅, the fixed delay period has ended, yet the system continues to wait before the sending the next pulse at least until VFB rises back above the second voltage threshold V_{BST_ON}.

During a sixth time period (t₆) another burst packet is provided of three sequential pulses, according to an embodiment. In this example, each pulse is sent at the first signal valley, although as noted above, pulses can also be sent during later valleys depending on the switching frequency. Furthermore, more than three pulses can be sent in some examples. A fixed delay is once again implemented following the delivery of a predetermined number of pulses during a seventh time period (t₇). Note, however, that in this instance VFB did not drop below the first voltage threshold V_{BST_OFF} during the delay period. As such, at the beginning of an eighth time period (t₈), the next pulse is immediately sent with no additional delay, according to some embodiments. During the eighth time period t₈, VFB begins to rise as the load demand is being met by the power converter. During the burst operation, VFB rises above the third voltage threshold V_{BST_EX}, which immediately exits the system from the burst mode. According to some embodiments, once burst mode has been exited, the system will not re-engage the burst mode until VFB falls below the first voltage threshold V_{BST_OFF}, and the system will not then send the first pulse until VFB rises above the second voltage threshold V_{BST_ON}.

### Methodology

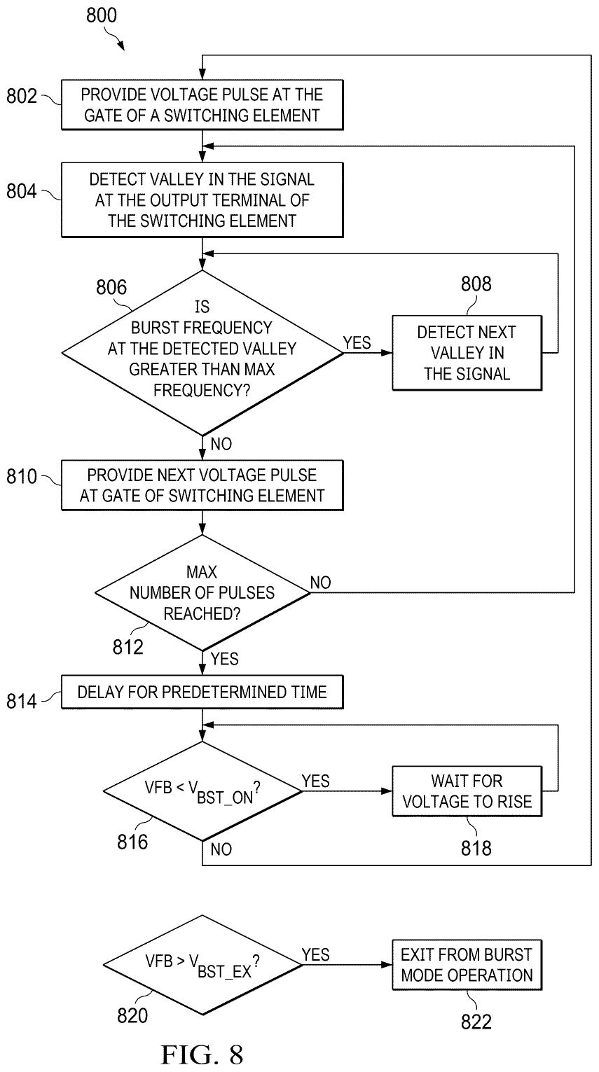

FIG. 8 illustrates a flow chart of a method 800 for a burst mode operation in a flyback power converter, in an example. The methodology can be carried out, for example, by the system 100 shown in FIG. 1 having the control circuit 103 of FIG. 2.

Method 800 beings with operation 802 where a first voltage pulse is provided to the gate of a switching element in the power converter. The voltage pulse may be a pulse-width modulated signal that is part of a burst packet having any predetermined number of pulses. During the delivery of the pulse, the switching element is biased on and the inductor of the flyback power converter is charged with the current flowing through the primary winding of the transformer, according to some embodiments.

Method 800 continues with operation 804 where a first valley of the signal at the switching terminal (e.g., drain terminal of the switching element) is detected. The valley may be detected within a ringdown of the signal at the switching terminal. Once the voltage pulse is removed from the gate of the switching element, the switching element turns off and the energy in the transformer is transferred to the load. After this, signal at the switching terminal begins to ring down as the parasitic capacitance at the switching terminal and the inductance of the primary coil of the transformer begin to resonate. As noted above, analog valley sensing logic may be used to determine the presence of a local minimum (e.g., a valley) in the ringdown of the switching terminal signal.

Method 800 continues with operation 806 where a determination is made regarding the burst frequency (e.g., switching frequency of the switching element) at the currently detected signal valley. If the current burst frequency is greater than a max threshold frequency (e.g., a max frequency of 250 kHz), then the next valley is detected in the signal at the switching terminal at operation 808. Once the next valley has been detected, method 800 returns to operation 806 to once again check to see if the current burst frequency is greater than the max threshold frequency. If the burst frequency is found to be less than the max threshold frequency, then method 800 continues to operation 810 where the next voltage pulse is provided to the gate of the switching element. This next pulse may be substantially similar to the first voltage pulse provided at operation 802.

Method 800 continues with operation 812 where a determination is made whether the max number of pulses has been reached. As noted above, a counter is used to keep track of the number of voltage pulses that have been delivered for the given burst packet. A predetermined max pulse threshold may be set to be anywhere from 3 pulses up to 10 pulses, or even more pulses. In the signal plots of FIG. 7, the max pulse threshold was set to three pulses, so each burst packet ended after delivering three pulses. If the max pulse threshold has not yet been reached, then method 800 returns to operation 804 to deliver the next voltage pulse to the gate of the switching element.

If the max pulse threshold has been reached, then method 800 continues to operation 814 where the system delays for a predetermined amount of time. According to some embodiments, the delay period may be different depending on the application, and may range between about 40μs and about 120μs, such as around 70μs. During the delay period, no voltage pulses are provided to the gate of the switching element, according to some embodiments. However, the burst mode is still enabled during this delay period and the system can continue to send another burst packet following the delay period.

Method 800 continues with operation 816 following the delay period at operation 814 where a determination is made regarding the feedback voltage VFB. If the feedback voltage is less than the second voltage threshold V_{BST_ON}, then method 800 continues to operation 818 where the system continues to wait for the feedback voltage to rise above the second voltage threshold V_{BST_ON}. For example, the system may wait until VFB rises above 0.3 V. According to some embodiments, once VFB is determined to be above the second voltage threshold V_{BST_ON}, or if VFB is already above the second voltage threshold V_{BST_ON} at the conclusion of operation 814, method 800 returns to operation 802 to send the first pulse of the next burst packet. Method 800 then proceeds with the same operations discussed above to send the pulses of the next burst packet.

According to some embodiments, method 800 continues to send burst packets to operate the switching element of the power converter until the burst mode is exited. Exiting from the burst mode occurs when VFB rises above the third voltage threshold V_{BST_EX} (e.g., around 0.5 V). According to some embodiments, the determination of whether VFB is above the third voltage threshold V_{BST_EX} at operation 820 can be performed at any time during the course of method 800. In this way, operation 820 may act as an interrupt to the flow of method 800, and as such is illustrated as separate from the main flow of method 800. If at any time VFB rises above the third voltage threshold V_{BST_EX}, method 800 continues from operation 820 to operation 822 where the system exits from the burst mode. In some examples, the determination in operation 820 is made at a specific time within method 800, rather than acting as an interrupt which can occur at any time. As noted above, burst mode can be re-entered (starting, for example, at operation 802) once VFB has dropped below the first voltage threshold V_{BST_OFF} and subsequently rises above the second voltage threshold V_{BST_ON.}

### Power System

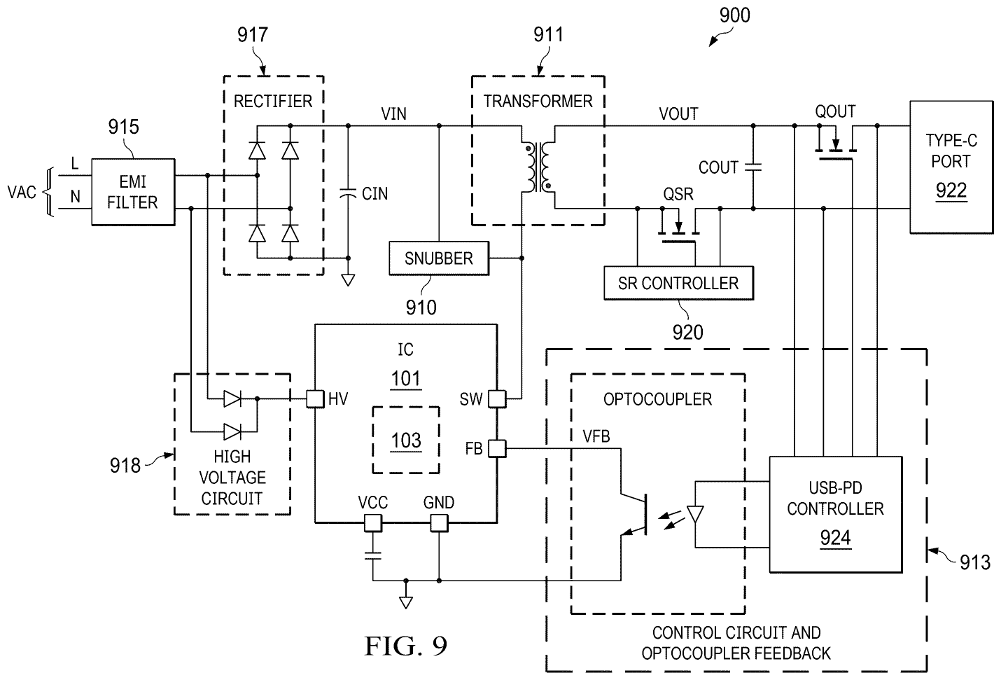

FIG. 9 illustrates a block diagram of a system 900 including a flyback power converter configured with an improved burst mode according to some embodiments of the present disclosure. As shown, system 900 includes a snubber 910, a flyback transformer 911, an EMI filter 915, a rectifier 917, an AC sense circuit 918, a synchronous rectification transistor QSR, a synchronous rectification (SR) controller 920, an output capacitor COUT, an output transistor QOUT, a port 922, a feedback circuit 913 that includes USB-PD controller 924 or an error amplifier and an optocoupler, and IC 101 that includes control circuit 103. In this example, system 900 converts an AC input voltage (VAC) to a DC input voltage (VIN) which is in turn converted by the flyback power converter to a regulated DC output voltage (VOUT). VOUT is in turn coupled to port 922 to which a load may be coupled. In other examples, the DC input voltage VIN may be sourced directly, rather than derived from AC input voltage VAC.

EMI filter 915 removes unwanted noise from being injected into the line voltage, rectifier 917 rectifies the AC input, and AC sense circuit 918 allows IC 101 to detect if VAC is present. Any suitable EMI filtering, rectifier, and sensing circuitry can be used. Other examples may have VIN directly applied rather than derived from an AC source as shown. In such cases, system 900 may not include VAC, EMI filter 915, rectifier 917, or AC sense circuit 918. Transformer 911 allows for energy storage, energy transfer, and galvanic isolation between the input VIN and output VOUT. Any suitable flyback transformer may be used. Snubber 910 provides a clamp voltage and may be implemented with any suitable snubber circuit. QSR and SR controller 920 collectively provide a synchronous rectifier (instead of DOUT in FIG. 1), which can be used to improve efficiency for flyback topologies.

Capacitor COUT operates in a similar fashion as described above, with reference to FIG. 1. In this example, port 922 is a type-C USB port, and controller 924 is a USB-PD controller. Other universal and proprietary port technologies may be used. QOUT can be used, for example, to disconnect the load, responsive to control from controller 924 if an over-voltage condition or high current condition is detected. The optocoupler provides feedback voltage VFB to IC 101 for use by control circuit 103, in some examples. The optocoupler provides isolation between the low voltage environment at the load and the high voltage environment at IC 101 by using light to transfer the voltage at the load into VFB at IC 101. However, any other electrical isolation circuit may be used in place of the optocoupler, such as any type of galvanic isolator, or through the use of one or more capacitors.

In this description, the term “couple” may cover connections, communications, or signal paths that enable a functional relationship consistent with this description. For example, if device A generates a signal to control device B to perform an action: (a) in a first example, device A is coupled to device B by direct connection; or (b) in a second example, device A is coupled to device B through intervening component C if intervening component C does not alter the functional relationship between device A and device B, such that device B is controlled by device A via the control signal generated by device A.

A device that is “configured to” perform a task or function may be configured (e.g., programmed and/or hardwired) at a time of manufacturing by a manufacturer to perform the function and/or may be configurable (or reconfigurable) by a user after manufacturing to perform the function and/or other additional or alternative functions. The configuring may be through firmware and/or software programming of the device, through a construction and/or layout of hardware components and interconnections of the device, or a combination thereof.

As used herein, the terms “terminal,” “interconnection,” “pin,” and “lead” are used interchangeably. Unless specifically stated to the contrary, these terms are generally used to mean an interconnection between or a terminus of a device element, a circuit element, an integrated circuit, a device or other electronics or semiconductor component.

A circuit or device that is described herein as including certain components may instead be adapted to be coupled to those components to form the described circuitry or device. For example, a structure described as including one or more semiconductor elements (such as transistors), one or more passive elements (such as resistors, capacitors, and/or inductors), and/or one or more sources (such as voltage and/or current sources) may instead include only the semiconductor elements within a single physical device (e.g., a semiconductor die and/or integrated circuit (IC) package) and may be adapted to be coupled to at least some of the passive elements and/or the sources to form the described structure either at a time of manufacture or after a time of manufacture, such as by an end user and/or a third party.

While the use of particular transistors is described herein, other transistors (or equivalent devices) may be used instead. For example, a p-channel field effect transistor (PFET) may be used in place of an n-channel field effect transistor (NFET) with little or no changes to the circuit. Furthermore, other types of transistors may be used (such as bipolar junction transistors (BJTs)). Furthermore, the devices may be implemented in/over a silicon substrate (Si), a silicon carbide substrate (SiC), a gallium nitride substrate (GaN) or a gallium arsenide substrate (GaAs), to name a few examples.

References herein to a field effect transistor (FET) being “on” means that the conduction channel of the FET is present and drain current may flow through the FET. References herein to a FET being “off” means that the conduction channel is not present and drain current does not flow through the FET. A FET that is off, however, may have current flowing through the transistor's body-diode.

Circuits described herein are reconfigurable to include additional or different components to provide functionality at least partially similar to functionality available prior to the component replacement. Components shown as resistors, unless otherwise stated, are generally representative of any one or more elements coupled in series and/or parallel to provide an amount of impedance represented by the resistor shown. For example, a resistor or capacitor shown and described herein as a single component may instead be multiple resistors or capacitors, respectively, coupled in parallel between the same terminals. In another example, a resistor or capacitor shown and described herein as a single component may instead be multiple resistors or capacitors, respectively, coupled in series between the same two terminals as the single resistor or capacitor.

Uses of the phrase “ground” in the foregoing description include a chassis ground, an Earth ground, a floating ground, a virtual ground, a digital ground, a common ground, and/or any other form of ground connection applicable to, or suitable for, the teachings of this description. In this description, unless otherwise stated, “about,” “approximately” or “substantially” preceding a parameter means being within +/−10 percent of that parameter.

### Further Examples

Example 1 is a device that includes a burst control circuit configured to receive a feedback voltage of a power converter and generate a burst enable signal, a pulse control circuit configured to receive the burst enable signal and a voltage signal of a current terminal of a switching element of the power converter, a delay control circuit configured to initiate a delay time, and a latch. The pulse control circuit is further configured to determine a timing between pulses to be delivered to the control terminal of the switching element and to assert a pulse enable signal. The delay time is initiated by the delay control circuit responsive to a delivered number of pulses reaching a maximum pulse threshold. The latch is designed to receive the pulse enable signal and a pulse reset signal, and to output a pulse to the control terminal of the switching element.

Example 2 includes the device of Example 1, wherein the burst control circuit includes: a first comparator configured to receive the feedback voltage at a first input and a first threshold voltage at a second input; and a second comparator configured to receive the feedback voltage at a first input and a second threshold voltage at a second input.

Example 3 includes the device of Example 2, further including: a first plurality of switches configured to change a value of the first threshold voltage; and a second plurality of switches configured to change a value of the second threshold voltage.

Example 4 includes the device of any one of Examples 1-3, wherein the pulse control circuit comprises a valley sensing circuit configured to detect a valley in the voltage signal.

Example 5 includes the device of Example 4, wherein the pulse control circuit comprises a frequency detection circuit configured to determine if a burst frequency at a time corresponding to the detected valley in the voltage signal is less than a threshold frequency.

Example 6 includes the device of Example 5, wherein the valley sensing circuit is configured to detect a next valley in the voltage signal responsive at least in part to the burst frequency being greater than the threshold frequency.

Example 7 includes the device of any one of Examples 4-6, wherein the pulse control circuit is configured to assert the pulse enable signal responsive at least in part to the valley sensing circuit detecting the valley in the voltage signal.

Example 8 includes the device of any one of Examples 1-7, wherein the delay time is between about 40 microseconds and 120 microseconds.

Example 9 includes the device of any one of Examples 1-8, wherein the delay control circuit comprises a counter configured to count a number of pulses delivered to the control terminal of the switching element.

Example 10 is a system that includes the device of any one of Examples 1-9, an input voltage terminal, an output voltage terminal, a switching terminal at which the voltage signal is provided, a feedback terminal at which the feedback voltage is provided, a transformer having a primary winding and a secondary winding with the primary winding coupled between the input voltage terminal and the switching terminal, and a feedback circuit coupled between the output voltage terminal and the feedback terminal.

Example 11 includes the device of Example 10, wherein the feedback circuit comprises an optocoupler circuit.

Example 12 includes the device of Example 10 or 11, wherein a load coupled to the output voltage terminal comprises a Universal Serial Bus (USB) port.

Example 13 is a control circuit that includes a valley counting circuit configured to count a number of valleys detected in a received voltage signal, a frequency clamp circuit configured to determine if a burst frequency corresponding to a time of a currently detected valley is less than a threshold frequency, and one or more logic gates. The valley counting circuit also asserts a valley enable signal upon counting one or more valleys in the received voltage signal. The frequency clamp circuit also asserts a clamp signal responsive to the burst frequency being less than the threshold frequency. The one or more logic gates are designed to receive at least the valley enable signal and the clamp signal and to assert a pulse enable signal at an output terminal of the one or more logic gates.

Example 14 includes the control circuit of Example 13, further including a valley sensing circuit configured to receive the voltage signal at a current terminal of a switching element of a power converter, detect a valley in the received voltage signal, and assert a valley detection signal responsive to detecting the valley in the received voltage signal.

Example 15 includes the control circuit of Example 14, wherein the one or more logic gates are further configured to receive the valley detection signal.

Example 16 includes the control circuit of any one of Examples 13-15, wherein the one or more logic gates includes at least one AND gate.

Example 17 includes the control circuit of any one of Examples 13-16, wherein the one or more logic gates is further configured to receive a burst enable signal, wherein the pulse enable signal is asserted responsive to each of at least the valley enable signal, clamp signal, and burst enable signal being asserted.

Example 18 includes the control circuit of any one of Examples 13-17, further comprising a switch configured to disconnect the output terminal from the one or more logic gates responsive to a burst exit signal being asserted.

Example 19 is a device that includes a burst control circuit configured to receive a feedback voltage of a power converter and generate a burst enable signal, the control circuit of any one of Examples 13-18, a delay control circuit configured to initiate a delay time during which no pulses can be delivered, and a latch configured to receive the pulse enable signal and to receive a pulse reset signal. The delay time is initiated responsive to a delivered number of pulses reaching a maximum pulse threshold. The latch is configured to output a pulse to a control terminal of a switching element.

Example 20 is a method of delivering a burst packet. The method includes delivering a first pulse at a first time to a control terminal of a switching element; detecting, at a second time, a first valley in a switching signal sampled at a current terminal of the switching element; and determining whether a first burst frequency associated with a time difference between the first time and the second time is less than a threshold frequency. Responsive to the first burst frequency being less than the threshold frequency, the method includes delivering a second pulse at the second time to the control terminal of the switching element. Responsive to the first burst frequency being greater than the threshold frequency, the method includes detecting, at a third time, a second valley in the switching signal, determining whether a second burst frequency associated with the time difference between the first time and the third time is less than the threshold frequency, and responsive to the second burst frequency being less than the threshold frequency, delivering a second pulse at the third time to the control terminal of the switching element.

Example 21 includes the method of Example 20, further comprising: responsive to the second burst frequency being greater than the threshold frequency, detecting, at a fourth time, a third valley in the switching signal, determining whether a third burst frequency associated with the time difference between the first time and the fourth time is less than the threshold frequency, and responsive to the third burst frequency being less than the threshold frequency, delivering a second pulse at the fourth time to the control terminal of the switching element.

Example 22 includes the method of Example 20 or 21, further comprising determining whether a number of delivered pulses has reached a predetermined max pulse threshold.

Example 23 includes the method of Example 22, further comprising, responsive to determining that the number of delivered pulses has reached the predetermined max pulse threshold, waiting for a predetermined delay time.

Example 24 includes the method of Example 23, wherein the predetermined delay time is between about 40 microseconds and 120 microseconds.

Example 25 includes the method of any one of Examples 22-24, further comprising, responsive to determining that the number of delivered pulses has not reached the predetermined max pulse threshold, delivering another pulse to the control terminal of the switching element.

Example 26 includes the method of any one of Examples 20-25, further comprising: receiving a feedback voltage; comparing the feedback voltage to a first threshold voltage at a first comparator; and comparing the feedback voltage to a second threshold voltage different from the first threshold voltage at a second comparator.

Example 27 includes the method of Example 26, further comprising: enabling a burst operation associated with delivering the first and second pulses, responsive to the feedback voltage being greater than the first threshold voltage; and disabling the burst operation, responsive to the feedback voltage being greater than the second threshold voltage.

Example 28 is a device that includes a burst control circuit configured to receive a feedback voltage of a power converter and generate a burst enable signal, a control circuit configured to receive the burst enable signal and a voltage signal of a current terminal of a switching element of the power converter, and a digital storage element. The control circuit is further configured to determine a timing between pulses to be delivered to a control terminal of the switching element, assert a pulse enable signal to deliver a pulse, and count a number of delivered pulses and determine if the number of delivered pulses is less than a maximum pulse threshold. The digital storage element is configured to receive the pulse enable signal and to output a pulse to the control terminal of the switching element.

Example 29 includes the device of Example 28, further comprising a delay circuit configured to initiate a delay time during which no pulses can be delivered to the control terminal of the switching element, the delay time initiated responsive to the number of delivered pulses reaching the maximum pulse threshold.

Example 30 includes the device of Example 29, wherein the delay time is between about 40 microseconds and 120 microseconds.

Example 31 includes the device of any one of Examples 28-30, wherein the burst control circuit comprises: a first comparator configured to receive the feedback voltage at a first input and a first threshold voltage at a second input; and a second comparator configured to receive the feedback voltage at a first input and a second threshold voltage at a second input.

Example 32 includes the device of Example 31, further comprising: a first plurality of switches configured to change a value of the first threshold voltage; and a second plurality of switches configured to change a value of the second threshold voltage.

Example 33 includes the device of any one of Examples 28-32, wherein the control circuit comprises a valley sensing circuit configured to detect a valley in the voltage signal.

Example 34 includes the device of Example 33, wherein the control circuit comprises a frequency detection circuit configured to determine if a burst frequency at a time corresponding to the detected valley in the voltage signal is less than a threshold frequency.

Example 35 includes the device of Example 34, wherein the valley sensing circuit is configured to detect a next valley in the voltage signal responsive at least in part to the burst frequency being greater than the threshold frequency.

Example 36 includes the device of any one of Examples 33-35, wherein the control circuit is configured to assert the pulse enable signal responsive at least in part to the valley sensing circuit detecting the valley in the voltage signal.

Example 37 includes the device of any one of Examples 28-36, wherein the digital storage element is a latch.

Example 38 is a system that includes: the device of any one of Examples 28-37, an input voltage terminal; an output voltage terminal; a switching terminal at which the voltage signal is provided; a feedback terminal at which the feedback voltage is provided; a transformer having a primary winding and a secondary winding with the primary winding coupled between the input voltage terminal and the switching terminal; and a feedback circuit coupled between the output voltage terminal and the feedback terminal.

Example 39 includes the system of Example 38, wherein the feedback circuit comprises an optocoupler circuit.

Example 40 includes the system of Example 38 or 39, wherein a load coupled to the output voltage terminal comprises a Universal Serial Bus (USB) port.

Modifications are possible in the described embodiments, and other embodiments are possible, within the scope of the claims.

What is claimed is:

1. A device, comprising:
a burst control circuit configured to receive a feedback voltage of a power converter and generate a burst enable signal;
a pulse control circuit configured to receive the burst enable signal and a voltage signal of a current terminal of a switching element of the power converter, the pulse control circuit further configured to determine a timing between pulses to be delivered to a control terminal of the switching element, and assert a pulse enable signal;
a delay control circuit configured to initiate a delay time, the delay time initiated responsive to a delivered number of pulses reaching a maximum pulse threshold; and
a latch configured to receive the pulse enable signal and to receive a pulse reset signal, the latch being configured to output a pulse to the control terminal of the switching element.

2. The device of claim 1, wherein the burst control circuit comprises:
a first comparator configured to receive the feedback voltage at a first input and a first threshold voltage at a second input; and
a second comparator configured to receive the feedback voltage at a first input and a second threshold voltage at a second input.

3. The device of claim 2, further comprising:
a first plurality of switches configured to change a value of the first threshold voltage; and
a second plurality of switches configured to change a value of the second threshold voltage.

4. The device of claim 1, wherein the pulse control circuit comprises a valley sensing circuit configured to detect a valley in the voltage signal.

5. The device of claim 4, wherein the pulse control circuit comprises a frequency detection circuit configured to determine if a burst frequency at a time corresponding to the detected valley in the voltage signal is less than a threshold frequency.

6. The device of claim 5, wherein the valley sensing circuit is configured to detect a next valley in the voltage signal responsive at least in part to the burst frequency being greater than the threshold frequency.

7. The device of claim 4, wherein the pulse control circuit is configured to assert the pulse enable signal responsive at least in part to the valley sensing circuit detecting the valley in the voltage signal.

8. The device of claim 1, wherein the delay control circuit comprises a counter configured to count a number of pulses delivered to the control terminal of the switching element.

9. A control circuit comprising:
a valley counting circuit configured to count a number of valleys detected in a received voltage signal, and to assert a valley enable signal upon counting one or more valleys in the received voltage signal;
a frequency clamp circuit configured to determine if a burst frequency corresponding to a time of a currently detected valley is less than a threshold frequency, and to assert a clamp signal responsive to the burst frequency being less than the threshold frequency; and
one or more logic gates configured to receive at least the valley enable signal and the clamp signal, and to assert a pulse enable signal at an output terminal of the one or more logic gates.

10. The control circuit of claim 9, further comprising a valley sensing circuit configured to:
receive the voltage signal at a current terminal of a switching element of a power converter, detect a valley in the received voltage signal, and
assert a valley detection signal responsive to detecting the valley in the received voltage signal.

11. The control circuit of claim 9, wherein the one or more logic gates is further configured to receive a burst enable signal, wherein the pulse enable signal is asserted responsive to each of at least the valley enable signal, clamp signal, and burst enable signal being asserted.

12. The control circuit of claim 9, further comprising a switch configured to disconnect the output terminal from the one or more logic gates responsive to a burst exit signal being asserted.

13. A device, comprising:
a burst control circuit configured to receive a feedback voltage of a power converter and generate a burst enable signal;
a control circuit configured to receive the burst enable signal and a voltage signal of a current terminal of a switching element of the power converter, the control circuit further configured to
determine a timing between pulses to be delivered to a control terminal of the switching element,
assert a pulse enable signal to deliver a pulse, and
count a number of delivered pulses and determine if the number of delivered pulses is less than a maximum pulse threshold; and
a digital storage element configured to receive the pulse enable signal and to output a pulse to the control terminal of the switching element.

14. The device of claim 13, further comprising a delay circuit configured to initiate a delay time during which no pulses can be delivered to the control terminal of the switching element, the delay time initiated responsive to the number of delivered pulses reaching the maximum pulse threshold.

15. The device of claim 13, wherein the burst control circuit comprises:
a first comparator configured to receive the feedback voltage at a first input and a first threshold voltage at a second input; and
a second comparator configured to receive the feedback voltage at a first input and a second threshold voltage at a second input.

16. The device of claim 15, further comprising:
a first plurality of switches configured to change a value of the first threshold voltage; and
a second plurality of switches configured to change a value of the second threshold voltage.

17. The device of claim 13, wherein the control circuit comprises a valley sensing circuit configured to detect a valley in the voltage signal.

18. The device of claim 17, wherein the control circuit comprises a frequency detection circuit configured to determine if a burst frequency at a time corresponding to the detected valley in the voltage signal is less than a threshold frequency.

19. The device of claim 18, wherein the valley sensing circuit is configured to detect a next valley in the voltage signal responsive at least in part to the burst frequency being greater than the threshold frequency.

20. The device of claim 17, wherein the control circuit is configured to assert the pulse enable signal responsive at least in part to the valley sensing circuit detecting the valley in the voltage signal.
